(19) United States
(12) Patent Application Publication
(10) Pub. No.: US 2024/0428638 A1
(43) Pub. Date: Dec. 26, 2024

(54) COIN HANDLING APPARATUS AND MONEY DEPOSITING/DISPENSING APPARATUS

(71) Applicant: FUJITSU FRONTECH LIMITED, Tokyo (JP)

(72) Inventors: Mitsuo WATANABE, Tokyo (JP); Ibuki KARIYA, Tokyo (JP)

(21) Appl. No.: 18/823,067

(22) Filed: Sep. 3, 2024

Related U.S. Application Data
(63) Continuation of application No. PCT/JP2022/013585, filed on Mar. 23, 2022.

(51) Int. Cl. G07D 1/06

(52) U.S. Cl. CPC G07D 1/06; G07D 2201/00

(57) ABSTRACT

A coin handling apparatus includes a coin receiver having a coin receiving port capable of collectively receiving a plurality of coins, a rotating plate disposed in the coin receiver and rotating to scoop up a coin in the coin receiver, a sorting plate provided with a coin hole having a size that makes it possible for a coin of a maximum size scooped up by the rotating plate to pass therethrough, and a large foreign object hole located on a downstream side of the coin hole in a rotation direction of the rotating plate and larger than the coin of the maximum size, a receiving passage connected to the coin hole of the sorting plate, and a discharge passage connected to the large foreign object hole of the sorting plate.

### CROSS-REFERENCE TO RELATED APPLICATION

This application is continuation application of International Application PCT/JP2022/013585 filed on Mar. 23, 2022 and designated the U.S., the entire contents of which are incorporated herein by reference.

### TECHNICAL FIELD

Embodiments discussed herein are related to a coin handling apparatus and a money depositing/dispensing apparatus including the coin handling apparatus.

### BACKGROUND ART

There is a money depositing/dispensing apparatus for depositing money for a product when a customer purchases the product at a store such as a supermarket or when a store clerk performs a checkout process for the product. Such a money depositing/dispensing apparatus includes a coin depositing/dispensing unit (coin depositing/dispensing apparatus) and a bill depositing/dispensing unit (bill depositing/dispensing apparatus).

In addition, there is a case where a coin receiving apparatus (coin depositing apparatus) that only receives coins is used. Usually, in the coin handling apparatus such as the aforementioned coin depositing/dispensing apparatus and coin receiving apparatus, coins are inserted one by one.

On the other hand, an apparatus capable of collectively inserting a plurality of coins has also been proposed (see, for example, JP 8-180240 A and JP 2003-144615 A).

### SUMMARY OF INVENTION

In one aspect, a coin handling apparatus includes a coin receiver having a coin receiving port capable of collectively receiving a plurality of coins, a rotating plate disposed in the coin receiver and rotating to scoop up a coin in the coin receiver, a sorting plate provided with a coin hole having a size that makes it possible for a coin of a maximum size scooped up by the rotating plate to pass therethrough, and a large foreign object hole located on a downstream side of the coin hole in a rotation direction of the rotating plate and larger than the coin of the maximum size, a receiving passage connected to the coin hole of the sorting plate, and a discharge passage connected to the large foreign object hole of the sorting plate.

In another aspect, a money depositing/dispensing apparatus includes the coin handling apparatus and a bill handling apparatus depositing/dispensing unit. The coin handling apparatus depositing and dispensing bill. The coin handling apparatus deposits and dispenses coins.

The object and advantages of the present invention will be realized by the elements set forth in the claims or combinations thereof.

### BRIEF DESCRIPTION OF DRAWINGS

FIG. 1 is a perspective schematic view illustrating an internal structure of a money depositing/dispensing apparatus according to an embodiment;

FIG. 2 is a front schematic view illustrating the internal structure of the money depositing/dispensing apparatus according to the embodiment;

FIG. 3 is a right schematic view illustrating the internal structure of the money depositing/dispensing apparatus according to the embodiment;

FIG. 4 is a front view illustrating an internal structure of a coin receiving unit according to the embodiment;

FIG. 5 is a view of a rotating plate and a sorting plate according to the embodiment as viewed in the V direction in FIG. 4;

FIG. 6 is a view of the sorting plate as viewed in the V direction in FIG. 4 with the rotating plate removed;

FIG. 7A is a right side view (part 1) illustrating a drawing operation of the coin receiving unit according to the embodiment;

FIG. 7B is a right side view (part 2) illustrating the drawing operation of the coin receiving unit according to the embodiment;

FIG. 8A is a front view (part 1) illustrating an inclination operation of the coin receiving unit according to the embodiment;

FIG. 8B is a front view (part 2) illustrating the inclination operation of the coin receiving unit according to the embodiment; and

FIG. 9 is a block diagram illustrating an example of a functional configuration of a controller unit according to the embodiment.

### DESCRIPTION OF EMBODIMENTS

Meanwhile, in an apparatus in which, in a coin receiving unit having a coin receiving port through which coins can be collectively inserted, coins are scooped up by rotation of a rotating plate and supplied to a receiving passage, a larger foreign object than a coin of a maximum size which is supposed to be inserted (the foreign object is, for example, a coin of a different country which is not supposed to be inserted) is not supplied to the receiving passage and continues to stay at the coin receiving unit in a case where the foreign object is inserted. In addition, the large foreign object hinders the conveyance of the coins.

Under such circumstances, it is conceivable to arrange a mechanism for eliminating the large foreign object, but in a case where such a mechanism operated by a different driving force from that for the rotating plate is provided, the structure of the coin handling apparatus becomes complicated.

Hereinbelow, a coin handling apparatus and a money depositing/dispensing apparatus according to an embodiment of the present invention will be described with reference to the drawings.

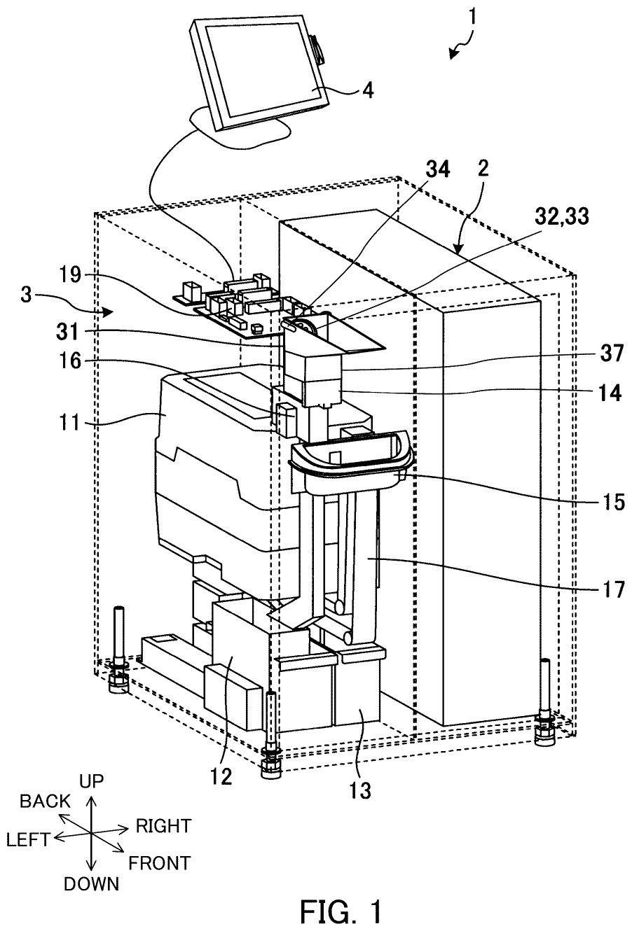

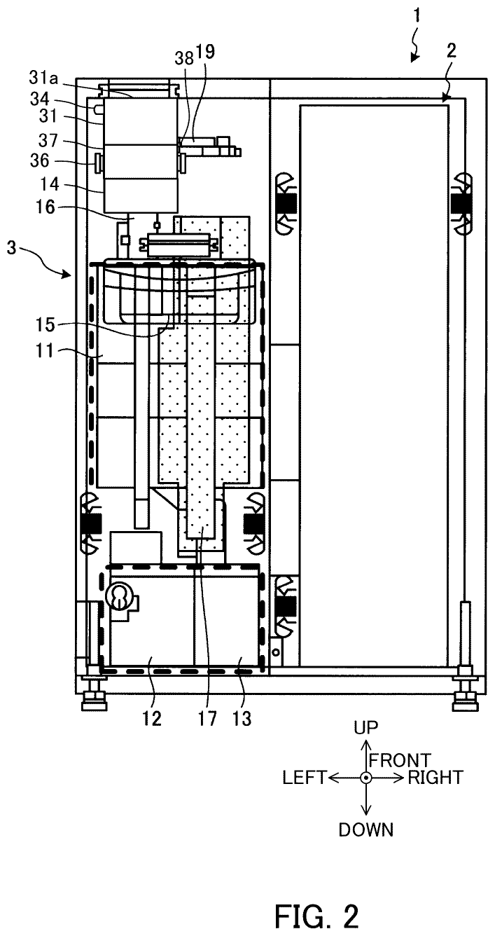

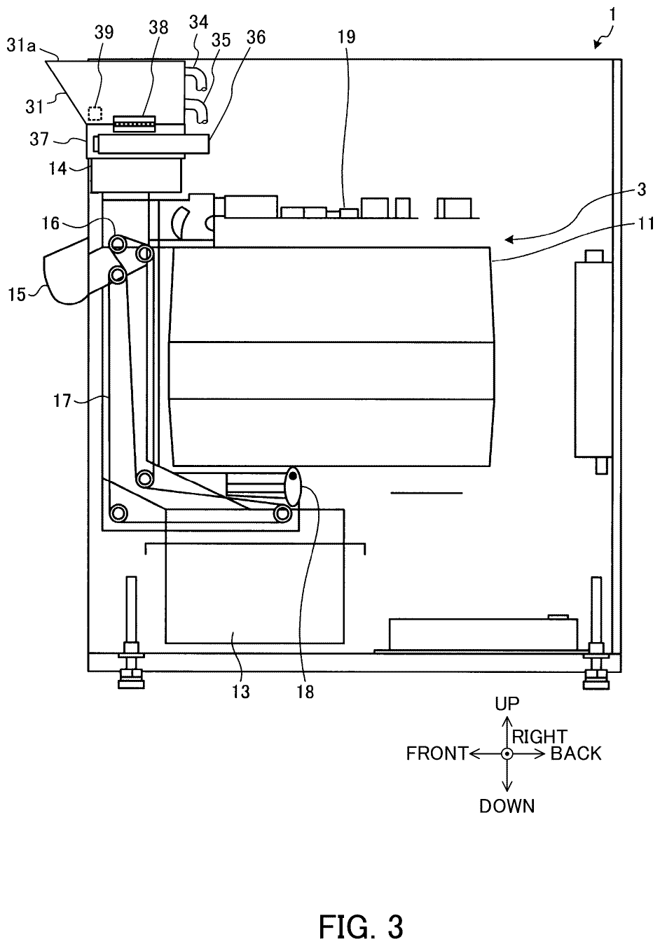

FIGS. 1 to 3 are a perspective schematic view, a front schematic view, and a right schematic view illustrating an internal structure of a money depositing/dispensing apparatus 1 according to an embodiment.

Note that the up-down, front-back, and right-left directions illustrated in FIGS. 1 to 3 and FIGS. 4 to 8B to be described below are illustrative only for a case where a customer (user) side of the money depositing/dispensing apparatus 1 is the front direction, and for example, the up-down direction is a vertical direction, and the front-back direction and the right-left direction are horizontal directions.

As illustrated in FIG. 1, the money depositing/dispensing apparatus 1 includes a bill recycling unit 2, a coin unit 3, and a controller unit 4. The money depositing/dispensing apparatus 1 is used, for example, in a store such as a supermarket in order for a customer or a store clerk to deposit or dispense money for a product, or in order for a store clerk to deposit or dispense money in a backyard of the store. The money depositing/dispensing apparatus 1 can be arranged at any place, as well as at a store.

The bill recycling unit 2 is a bill depositing/dispensing unit (bill handling apparatus) for depositing or dispensing bills.

The coin unit 3 is an example of a coin handling apparatus that handles coins, and is a coin depositing/dispensing unit (coin depositing/dispensing apparatus) for depositing or dispensing coins. The coin handling apparatus is only required to at least receive coins and is not limited to the apparatus (coin unit 3) used in the money depositing/dispensing apparatus 1. Note that the coin unit 3 (coin depositing/dispensing apparatus) may be used alone as a money depositing/dispensing apparatus without the bill recycling unit 2 (bill depositing/dispensing unit).

As illustrated in FIGS. 1 to 3, the coin unit 3 includes a coin receiving unit 31, a coin recycling unit 11, a coin overflow cassette 12, a coin recovery cassette 13, a coin acceptor 14, a coin dispensing unit 15, a coin sorter unit 16, a coin lifter unit 17, a coin recovery stopper unit 18, and a control unit 19. The coin unit 3 further includes a rotating plate 32, a sorting plate 33, a receiving passage 34, a discharge passage 35, a slide rail 36, a slider 37, a hinge 38, and a coin detecting sensor 39, which will be described below.

The controller unit 4 is a unit for providing a command to the money depositing/dispensing apparatus 1 and displaying information such as a state of the money depositing/dispensing apparatus 1 and a purchase amount for a product. The controller unit 4 will also be described below.

The coin receiving unit 31 has a coin receiving port 31a capable of collectively receiving a plurality of coins for a product billing amount or the like.

The coin recycling unit 11 is a unit that stores coins inserted through the coin receiving unit 31 and received from the coin acceptor (depositing port) 14 and stores coins that can be dispensed through the coin dispensing unit (dispensing port) 15.

The coin overflow cassette 12 is a unit that stores coins that cannot be dispensed through the coin dispensing unit 15. The coin stored in the coin overflow cassette 12 is a coin that has moved to avoid a full state of the coin recycling unit 11, and can thus be said to be, for example, a coin that can be reused in a store.

The coin recovery cassette 13 is a cassette that stores the recovered coins in the coin unit 3, particularly, in the coin recycling unit 11. The coins stored in the coin recovery cassette 13 are, for example, coins to be deposited in a bank as a sales amount.

The coin acceptor 14 has a discrimination function of discriminating coins inserted through the coin receiving unit 31. The discrimination function is a function of discriminating among a genuine coin, a counterfeit coin, a token coin, and the like. The discrimination function also includes a function of identifying the coin type.

The coin dispensing unit 15 is an example of a coin discharging unit that discharges coins from the coin unit 3 (coin handling apparatus), and dispenses coins such as change.

The coin sorter unit 16 sorts the coins supplied from the coin acceptor 14 and supplies the coins to the coin recycling unit 11, the coin overflow cassette 12, or the coin dispensing unit 15. Further, in a case where the coin is a genuine coin on the basis of the discrimination result using the discrimination function of the coin acceptor 14, the coin sorter unit 16 supplies the genuine coin to the coin recycling unit 11 or the coin overflow cassette 12. In a case where the coin is a counterfeit coin, the coin sorter unit 16 supplies the counterfeit coin to the coin dispensing unit 15.

The coin recovery stopper unit 18 is a stopper for opening and closing a coin discharge port for discharging coins for each coin type hopper in the coin recycling unit 11.

The coin lifter unit 17 is a lift (conveying unit) that conveys the coins discharged from the coin discharge port to the coin acceptor 14 according to an opening operation of the coin recovery stopper unit 18 and a forward rotation operation of the coin lifter unit 17. In addition, the coin lifter unit 17 is a lift (conveying unit) that conveys the coins discharged from the coin discharge port to the coin recovery cassette 13 according to the opening operation of the coin recovery stopper unit 18 and a reverse rotation operation of the coin lifter unit 17.

The control unit 19 includes, for example, a processor and a memory. The processor is, for example, a central processing unit (CPU) that functions as an arithmetic processing device that controls the operation of each unit of the coin unit 3. The memory is a read only memory (ROM) that is a read-only semiconductor memory in which a predetermined control program is recorded in advance, a random access memory (RAM) that is a semiconductor memory that is used as a working storage area as necessary when the processor executes various control programs and is writable and readable at any time, or the like.

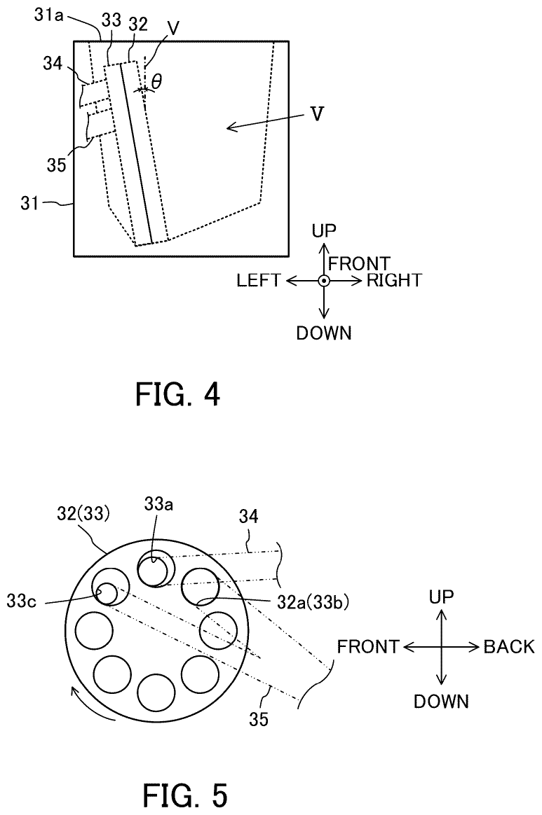

FIG. 4 is a front view illustrating an internal structure of the coin receiving unit 31.

FIG. 5 is a view of the rotating plate 32 and the sorting plate 33 as viewed in the V direction in FIG. 4.

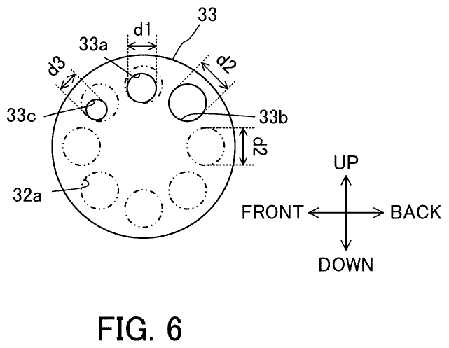

FIG. 6 is a view of the sorting plate 33 as viewed in the V direction in FIG. 4 with the rotating plate 32 removed.

As illustrated in FIG. 4, the inner bottom surface, indicated by the broken line, of the coin receiving unit 31 is inclined toward the bottom portion of the rotating plate 32 from the right portion to the central portion so as to guide the received coins to the rotating plate 32. In addition, as partially illustrated in FIG. 1, the inner bottom surface of the coin receiving unit 31 is inclined toward the bottom portion of the rotating plate 32 from the front portion to the back portion.

The rotating plate 32 is disposed in the coin receiving unit 31 at an inclination angle θ (for example, 10 degrees counterclockwise in FIG. 4) with respect to a virtual vertical plane V. The rotating plate 32 rotates to scoop up the coins in the coin receiving unit 31 (for example, clockwise in FIG. 5). As illustrated in FIG. 5, the rotating plate 32 is provided with, for example, eight holding holes 32a (illustrated in FIG. 6 by the two-dot chain line which is an imaginary line since the rotating plate 32 is omitted in FIG. 6) having the same size (diameter d2) as a large foreign object hole 33b of the sorting plate 33 to be described below at equal intervals in the rotation direction. The holding hole 32a holds a coin or a foreign object between the rotating plate 32 and the sorting plate 33 disposed to overlap with the left portion of the rotating plate 32 at the same inclination angle θ as that of the rotating plate 32.

As illustrated in FIG. 6, the sorting plate 33 is provided with a coin hole 33a having a size (diameter d1) that makes it possible for a coin of the maximum size scooped up by the rotating plate 32 to pass therethrough, the large foreign object hole 33b (diameter d2 (d2>d1)) located on the downstream side of the coin hole 33a in the rotation direction of the rotating plate 32 and larger than the coin of the maximum size, and a small foreign object hole 33c located on the upstream side of the coin hole 33a in the rotation direction of the rotating plate 32 and having a size (diameter d3 (d3<d1)) that makes it impossible for a coin of the minimum size scooped up by the rotating plate 32 to pass therethrough. Note that the upstream side and the downstream side in the rotation direction of the rotating plate 32 are those in a case where, when the rotating plate 32 makes one rotation with the bottom portion of the rotating plate 32 as a starting point, the early stage of the rotation is defined as an upstream end, and the last stage of the rotation is defined as a downstream end. In addition, the large foreign object hole 33b of the sorting plate 33 and the holding hole 32a of the rotating plate 32 are provided in the same size (diameter d2), but both are only required to be larger than the coin hole 33a (diameter d1). The sorting plate 33 is an example of a sorting member provided with at least the coin hole 33a and the large foreign object hole 33b, and its shape is not limited to a plate shape. Further, the small foreign object hole 33c of the sorting plate 33 may be omitted. In a case where the small foreign object hole 33c is omitted, a smaller foreign object than the coin of the minimum size is sent to the coin acceptor 14 together with coins, and is distinguished from the coins.

The receiving passage 34 illustrated by the broken line which is a hidden line in FIG. 4 and illustrated by the two-dot chain line which is an imaginary line in FIG. 5 is connected to the left end of the coin hole 33a of the sorting plate 33 and penetrates the left wall portion of the coin receiving unit 31 as illustrated in FIG. 1, for example. The receiving passage 34 sends the coin having passed through the coin hole 33a to the coin acceptor 14. Note that, in a case where the coin receiving unit 31 can be drawn out or can be inclined as described below, the receiving passage 34 is preferably made of a flexible material so as to allow the coin receiving unit 31 to perform the drawing operation or the inclination operation.

The discharge passage 35 illustrated by the broken line which is a hidden line in FIG. 4 and illustrated by the two-dot chain line which is an imaginary line in FIG. 5 is connected to the large foreign object hole 33b and the small foreign object hole 33c of the sorting plate 33, and penetrates the rear wall portion of the coin receiving unit 31, for example, although not illustrated. The discharge passage 35 sends the foreign object having passed through the large foreign object hole 33b and larger than the coin of the maximum size and the foreign object having passed through the small foreign object hole 33c and smaller than the coin of the minimum size to the coin dispensing unit 15. Note that, in the example indicated by the two-dot chain line in FIG. 5, the discharge passage 35 is bifurcated and connected to the large foreign object hole 33b and the small foreign object hole 33c, but two discharge passages may be provided independently one of which is connected to the large foreign object hole 33b and the other of which is connected to the small foreign object hole 33c. In addition, in a case where the coin receiving unit 31 can be drawn out or can be inclined, the discharge passage 35 is preferably made of a flexible material so as to allow the coin receiving unit 31 to perform the drawing operation or the inclination operation, in a similar manner to the case of the receiving passage 34.

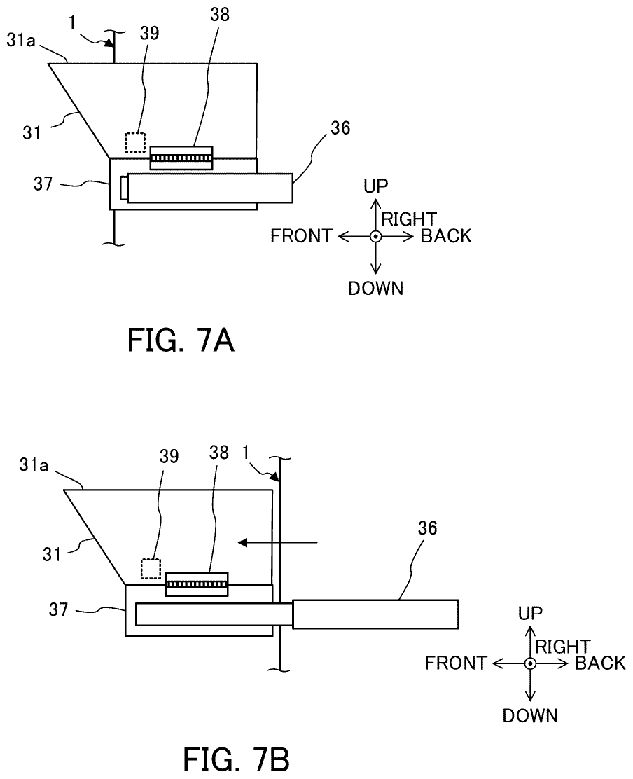

FIGS. 7A and 7B are right side views for explaining the drawing operation of the coin receiving unit 31.

As illustrated in FIGS. 7A and 7B, the slide rail 36 is disposed to draw out the coin receiving unit 31 forward (toward the customer). The slide rail 36 slidably holds the slider 37 connected to the lower portion of the coin receiving unit 31 in the front-back direction, thereby making the coin receiving unit 31 slidable in the front-back direction.

As illustrated in FIG. 7B, a person in charge or the like draws out the coin receiving unit 31 (slider 37) forward, for example, until the entire coin receiving unit 31 protrudes from the front surface of the money depositing/dispensing apparatus 1, whereby it is possible to easily remove the coin or the foreign object clogged inside the coin receiving unit 31.

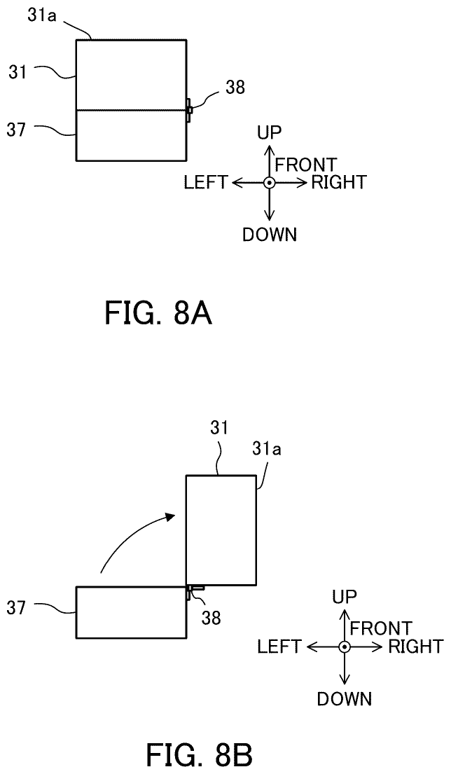

FIGS. 8A and 8B are front views for explaining the inclination operation of the coin receiving unit 31.

As illustrated in FIGS. 7A, 7B, 8A, and 8B, the hinge 38 is disposed at the right end boundary portion between the coin receiving unit 31 and the slide rail 36. The hinge 38 is an example of a support member that supports the coin receiving unit 31 in an inclinable manner.

As illustrated in FIG. 8B, for example, the hinge 38 supports the coin receiving unit 31 so that the coin receiving unit 31 is rotatable clockwise by 90 degrees until the coin receiving port 31a faces to the right. As a result, it is possible to easily remove the coin or the foreign object clogged inside the coin receiving unit 31. The inclination operation of the coin receiving unit 31 is preferably performed in a state where the coin receiving unit 31 is drawn forward as described above. Note that the inclination direction of the coin receiving unit 31 is not limited to the right direction, and may be the left direction, the front direction, or the like. In addition, the inclinable angle of the coin receiving unit 31 by the support of the hinge 38 (support member) is not limited to 90 degrees, and may be any angle.

For example, the coin detecting sensor 39 indicated by the broken line (hidden line) in FIGS. 7A and 7B detects a coin in the coin receiving unit 31 on the basis of the detection light emitted in the coin receiving unit 31 being shielded by the coin. The above-described rotating plate 32 preferably rotates on the basis of detection of a coin by the coin detecting sensor 39. The rotation operation of the rotating plate 32 is preferably performed, for example, by the above-described control unit 19 driving and controlling a rotation drive unit which is an actuator such as a not-illustrated motor. Note that the coin detecting sensor 39 may be omitted, and the rotating plate 32 may always rotate, for example, when the power of the money depositing/dispensing apparatus 1 is turned on, when coins are received in the coin receiving unit 31 (when insertion of coins is requested), or the like.

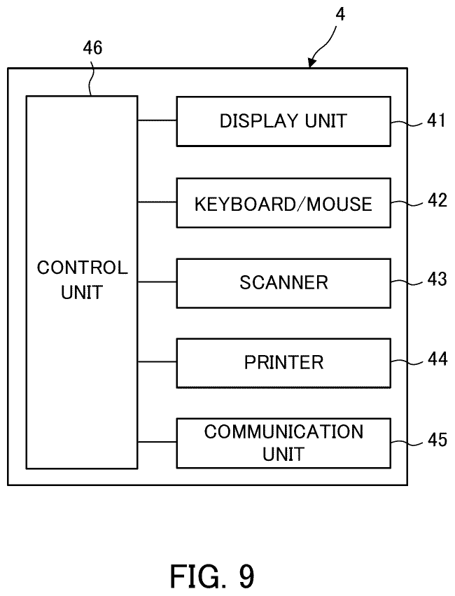

FIG. 9 is a block diagram illustrating an example of a functional configuration of the controller unit 4 illustrated in FIG. 1.

The controller unit 4 illustrated in FIG. 9 includes a display unit 41, a keyboard/mouse 42, a scanner 43, a printer 44, a communication unit 45, and a control unit 46.

The display unit 41 is, for example, an output interface that displays various types of information such as a product billing amount.

The keyboard/mouse 42 is, for example, an input interface for inputting various types of information such as a command.

The scanner 43 is, for example, an input interface that reads a barcode or the like attached to a product.

The printer 44 is, for example, an output interface that prints out various types of information such as a purchase receipt for a product or the like.

The communication unit 45 is a communication interface that connects the bill recycling unit 2 to the coin unit 3 by means of wireless communication.

The control unit 46 controls the entire controller unit 4. Note that the control unit 46 of the controller unit 4 preferably includes a processor, a memory, and the like similarly to the case of the control unit 19 of the coin unit 3.

In the present embodiment described above, the coin unit 3 which is an example of a coin handling apparatus includes the coin receiving unit 31 having the coin receiving port 31a capable of collectively receiving a plurality of coins, the rotating plate 32 disposed in the coin receiving unit 31 and rotating to scoop up a coin in the coin receiving unit 31, the sorting plate 33 provided with the coin hole 33a having a size (diameter d1) that makes it possible for a coin of a maximum size scooped up by the rotating plate 32 to pass therethrough, and the large foreign object hole 33b (diameter d2) located on a downstream side of the coin hole 33a in a rotation direction of the rotating plate 32 and larger than the coin of the maximum size and serving as an example of a sorting member, the receiving passage 34 connected to the coin hole 33a of the sorting plate 33, and the discharge passage 35 connected to the large foreign object hole 33b of the sorting plate 33.

In addition, in the present embodiment, the money depositing/dispensing apparatus 1 includes the coin handling apparatus and the bill recycling unit 2 serving as an example of a bill depositing/dispensing unit. The coin handling apparatus is a coin depositing/dispensing unit (for example, the coin unit 3).

According to the coin unit 3 and the money depositing/dispensing apparatus 1 described above, first, since the coin receiving port 31a of the coin receiving unit 31 can collectively receive a plurality of coins, the convenience of the customer can be enhanced. In addition, since the large foreign object hole 33b (diameter d2) larger than the coin of the maximum size is provided in the sorting plate 33, it is possible to prevent a larger foreign object than the coin of the maximum size (the foreign object is, for example, a coin of a different country which is not supposed to be inserted) from staying at the coin receiving unit 31 or hindering the conveyance of coins without the need for a mechanism operated by a different driving force from that for the rotating plate 32. Therefore, according to the present embodiment, a larger foreign object than a coin can be discharged with a simple configuration.

In addition, in the present embodiment, the sorting plate 33 is further provided with the small foreign object hole 33c located on an upstream side of the coin hole 33a in the rotation direction of the rotating plate 32 and having a size that makes it impossible for a coin of a minimum size scooped up by the rotating plate 32 to pass therethrough. The discharge passage 35 is connected to the large foreign object hole 33b and the small foreign object hole 33c.

As a result, it is possible to discharge not only a larger foreign object than the coin of the maximum size but also a smaller foreign object than the coin of the minimum size without the need for a mechanism operated by a different driving force from that for the rotating plate 32.

In addition, in the present embodiment, the coin unit 3 further includes the slide rail 36 for drawing out the coin receiving unit 31.

As a result, it is possible to easily remove a coin or a foreign object clogged inside the coin receiving unit 31 in a state where the coin receiving unit 31 is drawn out.

In addition, in the present embodiment, the coin unit 3 further includes the hinge 38 serving as an example of a support member supporting the coin receiving unit 31 in an inclinable manner.

As a result, it is possible to easily remove a coin or a foreign object clogged inside the coin receiving unit 31 in a state where the coin receiving unit 31 is inclined.

In addition, in the present embodiment, the coin unit 3 further includes the coin detecting sensor 39 detecting a coin in the coin receiving unit 31. The rotating plate 32 rotates on a basis of detection of a coin by the coin detecting sensor 39.

As a result, since the rotating plate 32 can be rotated only when a coin is inserted into the coin receiving unit 31, a foreign object can be discharged with low power consumption.

It is noted that the present invention is not limited to the above-described embodiment as it is, and can be embodied by modifying the components thereof. For example, various inventions can be formed by appropriately combining the plurality of components disclosed in the present embodiment. In this manner, various modifications and applications of the invention can be made without departing from the spirit of the invention.

1. A coin handling apparatus comprising:
a coin receiver having a coin receiving port capable of collectively receiving a plurality of coins;
a rotating plate disposed in the coin receiver and rotating to scoop up a coin in the coin receiver;
a sorting plate provided with a coin hole having a size that makes it possible for a coin of a maximum size scooped up by the rotating plate to pass therethrough, and a large foreign object hole located on a downstream side of the coin hole in a rotation direction of the rotating plate and larger than the coin of the maximum size;
a receiving passage connected to the coin hole of the sorting plate; and
a discharge passage connected to the large foreign object hole of the sorting plate.

2. The coin handling apparatus according to claim 1, wherein
the sorting plate is further provided with a small foreign object hole located on an upstream side of the coin hole in the rotation direction of the rotating plate and having a size that makes it impossible for a coin of a minimum size scooped up by the rotating plate to pass therethrough, and
the discharge passage is connected to the large foreign object hole and the small foreign object hole.

3. The coin handling apparatus according to claim 1, further comprising:
a slide rail for drawing out the coin receiver.

4. The coin handling apparatus according to claim 1, further comprising:
a hinge supporting the coin receiver in an inclinable manner.

5. The coin handling apparatus according to claim 1, further comprising:
a coin detecting sensor detecting a coin in the coin receiver,
wherein the rotating plate rotates on a basis of detection of a coin by the coin detecting sensor.

6. A money depositing/dispensing apparatus comprising:
the coin handling apparatus according to claim 1; and
a bill handling apparatus depositing and dispensing bills,
wherein the coin handling apparatus deposits and dispenses coins.
